(19) United States
(12) Patent Application Publication
(10) Pub. No.: US 2023/0091205 A1
(43) Pub. Date: Mar. 23, 2023

(54) MEMORY SIDE PREFETCH ARCHITECTURE FOR IMPROVED MEMORY BANDWIDTH

(71) Applicant: Intel Corporation, Santa Clara, CA (US)

(72) Inventors: Adrian Moga, Portland, OR (US); Ugonna Echeruo, Hillsboro, OR (US); Eduard Roytman, Newton Centre, MA (US); Krishnakanth Sistla, Portland, OR (US); Joseph Nuzman, Haifa (IL); Brinda Ganesh, Portland, OR (US); Meenakshisundaram Chinthamani, Hillsboro, OR (US); Yen-Cheng Liu, Portland, OR (US); Sai Prashanth Muralidhara, Portland, OR (US); Vivek Kozhikkottu, Portland, OR (US); Hanna Alam, Jish (IL); Narasimha Sridhar Srirangam, Santa Clara, CA (US)

(73) Assignee: Intel Corporation, Santa Clara, CA (US)

(21) Appl. No.: 17/479,582

(22) Filed: Sep. 20, 2021

(51) Int. Cl. G06F 12/0862; G06F 13/28

(52) U.S. Cl. CPC G06F 12/0862; G06F 13/28; G06F 2212/602

(57) ABSTRACT

Methods and apparatus relating to memory side prefetch architecture for improved memory bandwidth are described. In an embodiment, logic circuitry transmits a Direct Memory Controller Prefetch (DMCP) request to cause a prefetch of data from memory. A memory controller receives the DMCP request and issues a plurality of read operations to the memory in response to the DMCP request. Data read from the memory is stored in a storage structure in response to the plurality of read operations. Other embodiments are also disclosed and claimed.

### FIELD

The present disclosure generally relates to the field of electronics. More particularly, an embodiment relates to memory side prefetch architecture for improved memory bandwidth.

### BACKGROUND

For many workloads, performance is synonymous with the bandwidth at which data can be transferred between a processor and the memory subsystem. Depending on the usage scenario, the bandwidth bottleneck can be either the memory subsystem or the processor.

Hence, addressing such bottlenecks can enable higher performance for bandwidth-sensitive workloads.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system to provide a memory side prefetch architecture for improved memory bandwidth, according to an embodiment.

FIG. 2 illustrates a flow to provide memory side prefetch for improved memory bandwidth, according to an embodiment.

FIG. 3 illustrates a flow diagram of a method to provide memory side prefetch for improved memory bandwidth, according to an embodiment.

FIG. 4A is a block diagram illustrating both an exemplary in-order pipeline and an exemplary register renaming, out-of-order issue/execution pipeline according to embodiments.

FIG. 4B is a block diagram illustrating both an exemplary embodiment of an in-order architecture core and an exemplary register renaming, out-of-order issue/execution architecture core to be included in a processor according to embodiments.

FIG. 5 illustrates a block diagram of an SOC (System On Chip) package in accordance with an embodiment.

FIG. 6 is a block diagram of a processing system, according to an embodiment.

FIG. 7 is a block diagram of an embodiment of a processor having one or more processor cores, according to some embodiments.

FIG. 8 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, addressing bandwidth bottlenecks at a processor/core (demand saturation) and/or at a memory subsystem (supply saturation) can enable higher performance for bandwidth-sensitive workloads. At least one embodiment addresses both kinds of bottlenecks and enables higher performance for bandwidth-sensitive workloads.

Moreover, some solutions for increasing core demand bandwidth include deeper out-of-order execution or core-side prefetching at cacheline (e.g., 64B, where “B” stands for byte) granularity to produce memory addresses at a maximal rate. This may be combined with an increase in various core micro-architecture structures which track memory requests-in-flight (e.g., by using fill buffers, etc.). In some cases, prefetch requests may be tracked off-core but data may also be stored off-core (e.g., by performing Last Level Cache (LLC)) prefetching), so that a later core request can retrieve the data at a faster latency from the LLC than from memory. Disadvantages of core-driven memory requests stem primarily from using fine-grain 64B requests in tracking, routing, and scheduling layers. More trackers are required to store 64B requests-in-flight and more mesh and uncore pipeline passes are required to route and process 64B requests. Less spatial locality exposed to the memory scheduler after 64B requests are scattered across caching agents and arrive out-of-order at the memory controller.

Further, some solutions for increasing supply bandwidth rely on memory controller scheduling optimizations to maximize DRAM (dynamic random access memory) page hits and to minimize various device timing penalties, such as RD/WR (read/write) turnaround. The resulting sustained bandwidth as a ratio of peak theoretical bandwidth is referred to as “memory efficiency.” The memory address entropy problem at the memory controller is compounded by the mixing of address streams from many sources (e.g., cores, I/O (input/output or “IO”), requests from remote socket(s), LLC victims, accelerators, etc.). Some workloads (like STREAM, BWAVES, PAREST, etc.) include highly sequential streams. In the absence of competing requests from other cores, the memory controller efficiently exploits DRAM page hits (e.g., with lowest latency) to minimize the power and data return latency. Additionally, to minimize the power and potential future page-misses, memory controller would likely auto-close the page, if it does not find any potential requests that would generate page-hits. Thus, the number of threads is increased, even a purely sequential workload would likely have lower page-hits and higher page-misses/higher page-empty cases.

In addition, disadvantage of LLC prefetching can be two-fold. They consume precious LLC capacity to store data which is either volatile (if prefetch is used) or polluting (if prefetch is unused). In some designs, LLC prefetches chased by demands can cause pipeline rejections, resulting in IRQ (interrupt request) buildup and increase in power consumption. Also, accommodating LLC prefetches may result in overloading some bit fields. The informational loss may cause side effects for overall performance.

To this end, some embodiments provide memory side prefetch architecture for improved memory bandwidth. An embodiment utilizes relatively large granularity (e.g., multiple cachelines) core read requests directly to the memory controllers with a single packet/request. This packet/request is untracked contrary to the above-mentioned implementations. Another embodiment provides memory-side prefetching using page open mode and buffering of the prefetched data, e.g., in a low latency storage structure such as a memory controller buffer/cache (MC$) or another cache or buffer, also sometimes referred to herein as Memory Side Cache (MSC). In an embodiment, data stored in a buffer may be released after it is read once, whereas a cache can maintain the data after the data is read (e.g., for later use).

As discussed herein, a “page open mode” refers to a mode for Random Access Memory (RAM) devices (including for example DRAM devices, DDR (double data rate) memory devices, etc.) where an activated row is powered up and readily accessible instead of having to wait for activation (which causes latency) and additional power consumption (to activate the row).

In some embodiments, one or more of the following features may be provided: (1) memory-side prefetching reduces the effective latency, which in turn boosts the core's ability to demand higher bandwidth per core (e.g., the demand bandwidth per core is a fundamental performances metric for memory-bandwidth-bound workloads found in AI (artificial intelligence) and HPC (High Performance Computing) domains, resulting in improved efficiency of in-core accelerators, increased IPC (instructions per cycle) and higher workload performance); (2) the large granularity requests lead to higher efficiency via higher rate of page hits, relieving in-core pressure to build and track large tracking structures in support of high bandwidth demand, and reduce overheads to mesh control and data plane due to multi-lane requests as compared to, for example, individual (e.g., 64B) single line requests; and/or (3) applicability of some embodiments is not limited to integrated (also referred to herein as “native”) memory controllers and native memory. Further, due to addressing effective latency, a fundamental limiter to performance and to consumable bandwidth per core, at least some embodiments are scalable and extendable to a variety of current and future system architectures inclusive but not limited to: (a) native implementations with and without memory-side cache; and/or (b) remote, shared, pooled memory controller, and memory implementation with and without memory-side cache.

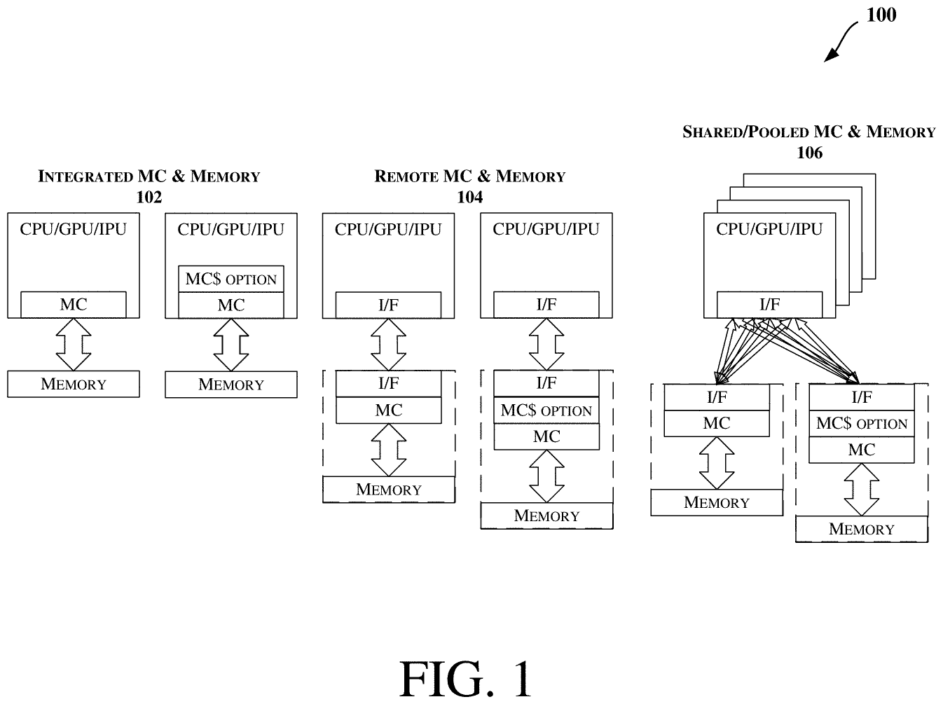

FIG. 1 illustrates a block diagram of a system 100 to provide a memory side prefetch architecture for improved memory bandwidth, according to an embodiment. In FIG. 1, “MC” refers to memory controller, “I/F” stands for interface, “$” is short for cache, “GPU” stands for graphics processing unit, and “IPU” refers to Infrastructure Processing Unit.

System 100 may include various types of memory, such as an integrated memory controller and memory 102, remote memory controller and memory 104, and/or shared/pooled memory controller and memory 106. As shown in FIG. 1, in a shared/polled MC and memory combination 106, multiple CPU/GPU/IPU may share access to memory that is polled/shared amongst the multiple CPU/GPU/IPU. However, embodiments are not limited to these types of memory subsystems may be used. As shown, each MC/memory combination may be coupled to a CPU/processor, GPU, or IPU.

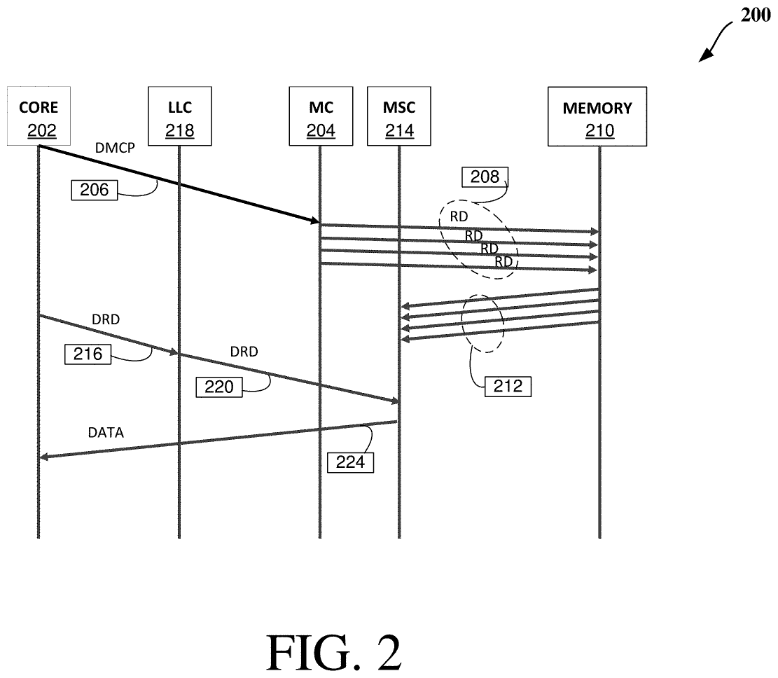

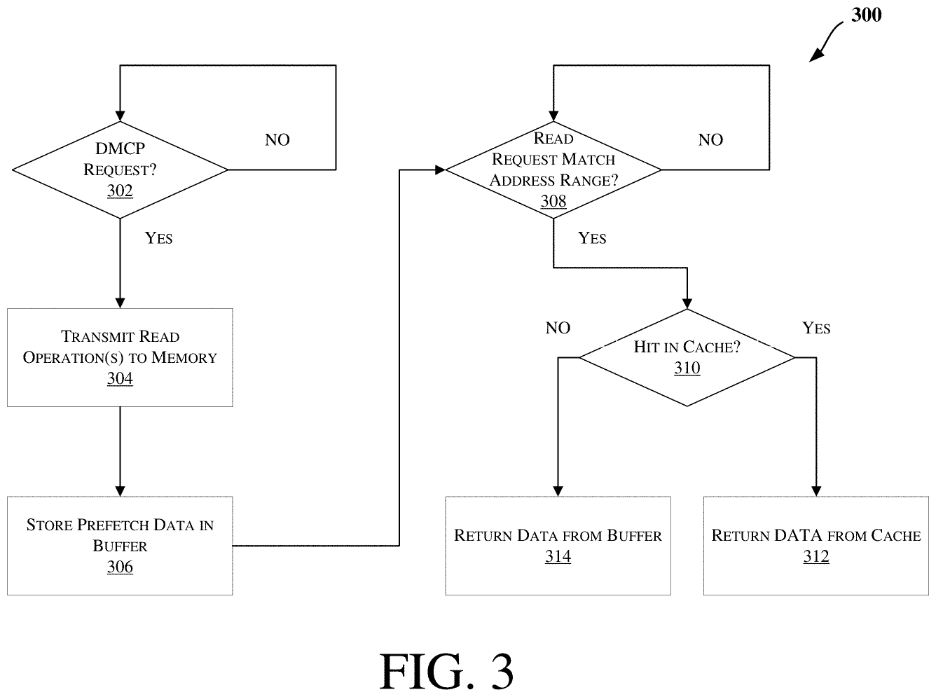

In an embodiment, a memory controller includes (or otherwise has access to) a buffer (or cache) to temporarily store an address and its corresponding data prefetched based on a Direct Memory Controller Prefetch (DMCP) request, as will be further discussed herein, e.g., with reference to FIGS. 2-3. This buffer is sometimes referred to herein interchangeable as MC$ or MSC. The buffer may be integrated in a memory controller or be discreet and coupled to the memory controller. In either case, the memory controller will have access to this data to support prefetch operations, such as discussed with reference to FIGS. 2 and/or 3.

FIG. 2 illustrates a flow diagram of a method 200 to provide memory side prefetch for improved memory bandwidth, according to an embodiment. An embodiment relies on a direct read flow between core 202 and MC 204, called DMCP or Direct Memory Controller Prefetch. The flow uses a latency reduction mechanism (e.g., a buffer as discussed with reference to FIG. 1) to speed-up a core read operation (demand or prefetch) to the memory subsystem(s). The DMCP request 206 originates at the core 202 as a form of prefetch operation. However, embodiments are not limited to only the core 202 originating the request 206, and any entity that observes core traffic (such as the MC 214, IO agent(s), and/or other logic circuitry in a processor or external to a processor) can originate the request 206. An DMCP packet/request may include one or more fields indicating one or more addresses for the data to be read (where the one or more fields may indicate a starting address and size for the data to be read, or a starting address, size, and stride, for example) in an embodiment.

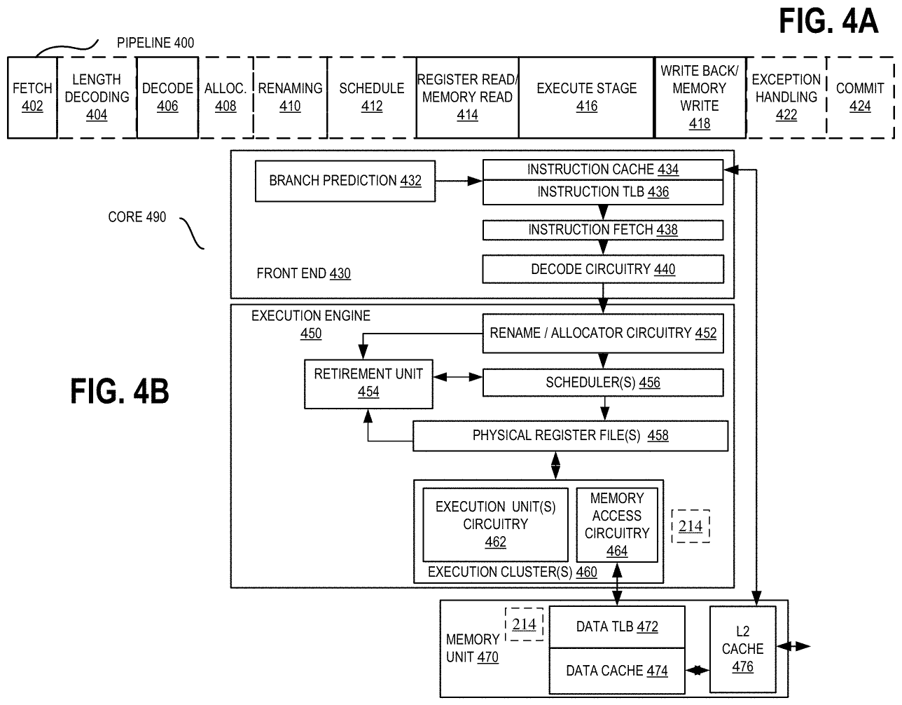

In some embodiments, the memory controller 204 treats the DMCP request 206 as a sequence of multiple read requests and schedules the corresponding read commands (RD) 208 for each of the DMCP requests to the memory device 210. In an embodiment, the MC 204 is outside of the coherency domain for the memory 210 and/or LLC 218 (e.g., to avoid potential deadlocks). The memory device 210 may be any type of memory such as those discussed with reference to FIG. 1 and FIG. 4A et seq. In doing so, at least n−1 requests can exploit page open mode; thus, resulting in higher page hits and improving the memory efficiency of the memory controller 204.

Upon data return 212 (in response to the read commands 208) from the memory 210, the MC 204 stores the data into an MSC 214. As discussed with reference to FIG. 1, an MSC may be integrated in an MC as a buffer/cache or be a discreet component (and accessible by the MC).

At a later point in time, the core 202 may issue a (e.g., 64B) read request (DRD or DRDPREF) 216 for an address falling in the range of the prior DMCP prefetch 206. If so, DRD 216 will follow the flow to LLC 218 and (upon a miss in LLC 218) to MC (220). When reaching MC 204, data is readily retrieved 224 from the MSC 214; thus, fulfilling the lower latency and/or power consumption reduction premise of one or more embodiments.

With one or more embodiments, most memory data can be prefetched using DMCP and later provided to a core at a latency close to an LLC hit. As discussed with reference to FIG. 1, this benefit can also apply to multi-core scenarios in products with ample supply-side bandwidth (such as HBM). Further, consumable bandwidth per core is a fundamental performance metric for memory-bandwidth-bound workloads, such as AI training, AI inference and HPC. At least one embodiment addresses effective latency to memory and substantially boosts effective consumable bandwidth per core, a highly visible and requested feature, which in turn maximizes efficiency of in-core accelerators, improves IPC and results in higher workload performance.

FIG. 3 illustrates a flow diagram of a method 300 to provide memory side prefetch for improved memory bandwidth, according to an embodiment. One or more components discussed with reference to FIGS. 1 and/or 2 may be used to perform one or more operations of method 300, as further discussed herein.

Referring to FIGS. 1-3, at operation 302, once a DMCP request (e.g., from a processor core such as core 202) is received (e.g., by MC 204), a memory controller (e.g., MC 204) transmits read operation(s) to memory (e.g., memory 210) at operation 304. At operation 306, the returned/prefetched data form the memory (received in response to the read operation(s) of operation 304) is stored (e.g., by MC 204) in a buffer (e.g., MSC 214 or another buffer or cache integrated or otherwise accessible by the memory controller).

At a later point in time, once a read operation (e.g., from a processor core (such as core 202) is received) that matches an address in the collection of addresses stored in the buffer (e.g., MSC 214 or another buffer or cache integrated or otherwise accessible by the memory controller) at operation 308, the address is looked up in a cache (e.g., LLC 218 or another cache). If there is a hit, then data is returned from the cache at operation 312. If there is a miss at operation 310, data is returned from the buffer (e.g., the buffer that stores the prefetch data at operation 306).

Additionally, the applicability of one or more embodiments is not limited to native memory controllers and native memory. For example, some embodiments address effective latency, a fundamental limiter to performance and to demand bandwidth, and such embodiments are scalable and extendable to variety of current and future system architectures inclusive but not limited to: (1) CPUs, GPUs, IPUs and any other data processing units accessing memory; (2) native implementations with and without optional memory side cache add-on; and/or (3) remote, intra-node and inter-node shared and/or pooled memory controller and memory architectures with and without optional memory side cache add-on.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

FIG. 4A is a block diagram illustrating both an exemplary in-order pipeline and an exemplary register renaming, out-of-order issue/execution pipeline according to embodiments. FIG. 4B is a block diagram illustrating both an exemplary embodiment of an in-order architecture core and an exemplary register renaming, out-of-order issue/execution architecture core to be included in a processor according to embodiments. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front end unit 430 includes a branch prediction unit 432 coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a writemask registers unit, and a scalar registers unit. These register units may provide architectural vector registers, vector mask registers, and general purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 454 and the physical register file(s) unit(s) 458 are coupled to the execution cluster(s) 460.

The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 4) the memory unit 470 and the physical register file(s) unit(s) 458 perform the write back/memory write stage 418; 4) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 490 includes logic to support a packed data instruction set extension (e.g., AVX1, AVX2), thereby allowing the operations used by many multimedia applications to be performed using packed data.

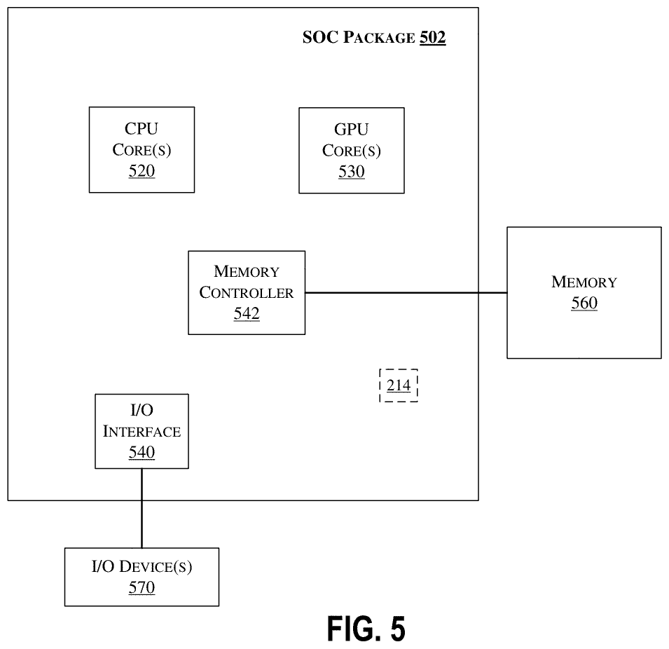

FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 502 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

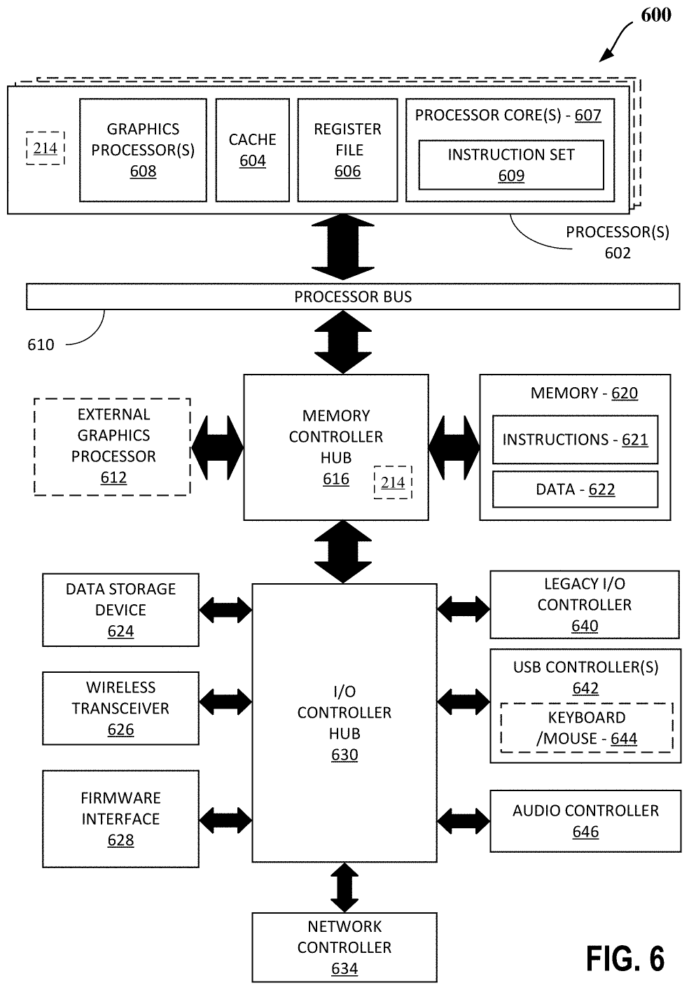

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary ‘hub’ system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random access memory (DRAM) device, a static random access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

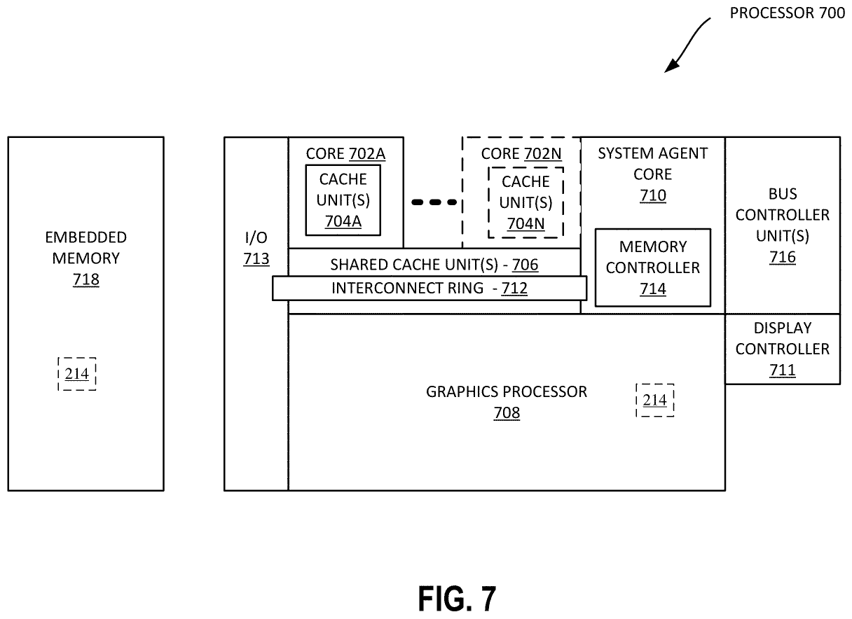

FIG. 7 is a block diagram of an embodiment of a processor 700 having one or more processor cores 702A to 702N, an integrated memory controller 714, and an integrated graphics processor 708. Those elements of FIG. 7 having the same reference numbers (or names) as the elements of any other figure herein can operate or function in any manner similar to that described elsewhere herein, but are not limited to such. Processor 700 can include additional cores up to and including additional core 702N represented by the dashed lined boxes. Each of processor cores 702A to 702N includes one or more internal cache units 704A to 704N. In some embodiments each processor core also has access to one or more shared cached units 706.

The internal cache units 704A to 704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A to 704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A to 702N include support for simultaneous multi-threading. In such embodiment, the system agent core 710 includes components for coordinating and operating cores 702A to 702N during multi-threaded processing. System agent core 710 may additionally include a power control unit (PCU), which includes logic and components to regulate the power state of processor cores 702A to 702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect, or may be integrated within the graphics processor 708 or system agent core 710.

In some embodiments, a ring based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702 to 702N and graphics processor 708 use embedded memory modules 718 as a shared Last Level Cache.

In some embodiments, processor cores 702A to 702N are homogenous cores executing the same instruction set architecture. In another embodiment, processor cores 702A to 702N are heterogeneous in terms of instruction set architecture (ISA), where one or more of processor cores 702A to 702N execute a first instruction set, while at least one of the other cores executes a subset of the first instruction set or a different instruction set. In one embodiment processor cores 702A to 702N are heterogeneous in terms of microarchitecture, where one or more cores having a relatively higher power consumption couple with one or more power cores having a lower power consumption. Additionally, processor 700 can be implemented on one or more chips or as an SoC integrated circuit having the illustrated components, in addition to other components.

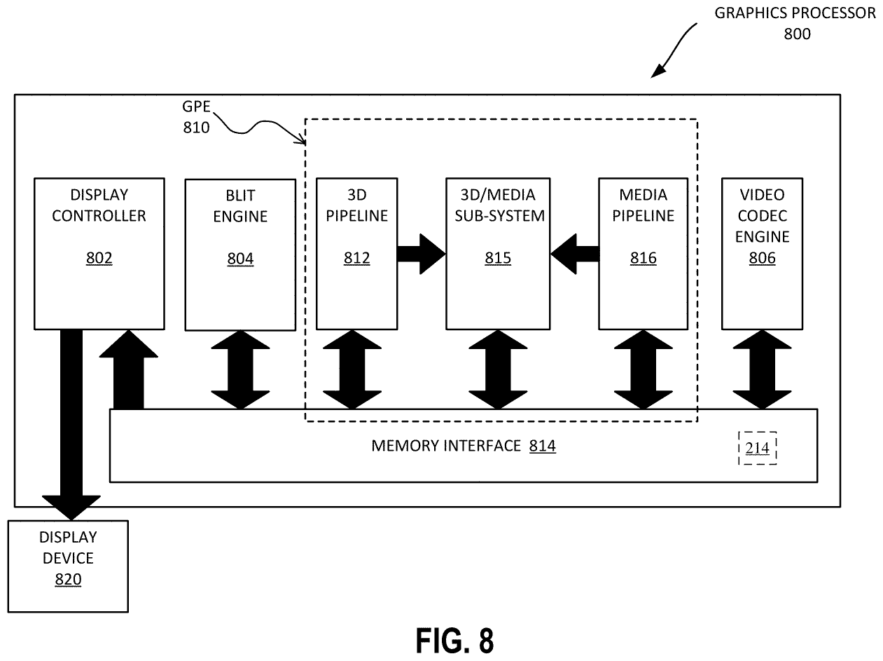

FIG. 8 is a block diagram of a graphics processor 800, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 800 includes a memory interface 814 to access memory. Memory interface 814 can be an interface to local memory, one or more internal caches, one or more shared external caches, and/or to system memory.

In some embodiments, graphics processor 800 also includes a display controller 802 to drive display output data to a display device 820. Display controller 802 includes hardware for one or more overlay planes for the display and composition of multiple layers of video or user interface elements. In some embodiments, graphics processor 800 includes a video codec engine 806 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 800 includes a block image transfer (BLIT) engine 804 to perform two-dimensional (2D) rasterizer operations including, for example, bit-boundary block transfers. However, in one embodiment, 3D graphics operations are performed using one or more components of graphics processing engine (GPE) 810. In some embodiments, graphics processing engine 810 is a compute engine for performing graphics operations, including three-dimensional (3D) graphics operations and media operations.

In some embodiments, GPE 810 includes a 3D pipeline 812 for performing 3D operations, such as rendering three-dimensional images and scenes using processing functions that act upon 3D primitive shapes (e.g., rectangle, triangle, etc.). The 3D pipeline 812 includes programmable and fixed function elements that perform various tasks within the element and/or spawn execution threads to a 3D/Media sub-system 815. While 3D pipeline 812 can be used to perform media operations, an embodiment of GPE 810 also includes a media pipeline 816 that is specifically used to perform media operations, such as video post-processing and image enhancement.

In some embodiments, media pipeline 816 includes fixed function or programmable logic units to perform one or more specialized media operations, such as video decode acceleration, video de-interlacing, and video encode acceleration in place of, or on behalf of video codec engine 806. In some embodiments, media pipeline 816 additionally includes a thread spawning unit to spawn threads for execution on 3D/Media sub-system 815. The spawned threads perform computations for the media operations on one or more graphics execution units included in 3D/Media sub-system 815.

In some embodiments, 3D/Media subsystem 815 includes logic for executing threads spawned by 3D pipeline 812 and media pipeline 816. In one embodiment, the pipelines send thread execution requests to 3D/Media subsystem 815, which includes thread dispatch logic for arbitrating and dispatching the various requests to available thread execution resources. The execution resources include an array of graphics execution units to process the 3D and media threads. In some embodiments, 3D/Media subsystem 815 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: logic circuitry to transmit a Direct Memory Controller Prefetch (DMCP) request to cause a prefetch of data from memory; a memory controller to receive the DMCP request and issue a plurality of read operations to the memory in response to the DMCP request, wherein data read from the memory in response to the plurality of read operations is to be stored in a storage structure. Example 2 includes the apparatus of example 1, wherein the storage structure comprises one or more of: a buffer, a cache, a memory side cache, or a memory controller cache. Example 3 includes the apparatus of example 2, wherein the cache comprises a Last Level Cache (LLC). Example 4 includes the apparatus of example 1, wherein one or more of a processor, the memory controller, and an input/output agent comprise the logic circuitry. Example 5 includes the apparatus of example 1, wherein the data stored in the storage structure is to be used to service a subsequent read request from a processor. Example 6 includes the apparatus of example 1, wherein the memory controller is to store the data read from the memory in the storage structure in response to the plurality of read operations. Example 7 includes the apparatus of example 1, wherein the storage structure is a discrete component from the memory controller, wherein the memory controller is communicatively coupled to the storage structure to allow the memory controller to read/write data from/to the storage structure. Example 8 includes the apparatus of example 1, wherein a page open mode of the memory is to be utilized for the data read from the memory. Example 9 includes the apparatus of example 1, wherein, in response to a read request by a processor for an address that matches an address of an entry stored in the storage structure, the read request is to be serviced from the stored data in the storage structure after a miss in a cache. Example 10 includes the apparatus of example 9, wherein the cache comprises a Last Level Cache (LLC). Example 11 includes the apparatus of example 1, wherein the logic circuitry is to directly transmit the DMCP request to the memory controller. Example 12 includes the apparatus of example 1, wherein a processor core comprises the logic circuitry, wherein the processor core is to transmit the DMCP request to the memory controller. Example 13 includes the apparatus of example 1, wherein the memory comprises one or more of: a memory device with an integrated memory controller, a remote memory with a remote memory controller, and a shared or pooled memory with a shared or pooled memory controller.

Example 14 includes one or more non-transitory computer-readable media comprising one or more instructions that when executed on a processor configure the processor to perform one or more operations to cause: logic circuitry to transmit a Direct Memory Controller Prefetch (DMCP) request to cause a prefetch of data from memory; a memory controller to receive the DMCP request and issue a plurality of read operations to the memory in response to the DMCP request, wherein data read from the memory in response to the plurality of read operations is to be stored in a storage structure. Example 15 includes the one or more computer-readable media of example 14, wherein the storage structure comprises one or more of: a buffer, a cache, a memory side cache, or a memory controller cache. Example 16 includes the one or more computer-readable media of example 15, wherein the cache comprises a Last Level Cache (LLC). Example 17 includes the one or more computer-readable media of example 14, wherein one or more of the processor, the memory controller, and an input/output agent comprise the logic circuitry. Example 18 includes the one or more computer-readable media of example 14, further comprising one or more instructions that when executed on the at least one processor configure the at least one processor to perform one or more operations to cause the data stored in the storage structure is to be used to service a subsequent read request from the processor. Example 19 includes the one or more computer-readable media of example 14, further comprising one or more instructions that when executed on the at least one processor configure the at least one processor to perform one or more operations to cause the memory controller to store the data read from the memory in the storage structure in response to the plurality of read operations. Example 20 includes the one or more computer-readable media of example 14, wherein the storage structure is a discrete component from the memory controller, wherein the memory controller is communicatively coupled to the storage structure to allow the memory controller to read/write data from/to the storage structure. Example 21 includes the one or more computer-readable media of example 14, further comprising one or more instructions that when executed on the at least one processor configure the at least one processor to perform one or more operations to cause a page open mode of the memory to be utilized for the data read from the memory. Example 22 includes the one or more computer-readable media of example 14, further comprising one or more instructions that when executed on the at least one processor configure the at least one processor to perform one or more operations to cause, in response to a read request by the processor for an address that matches an address of an entry stored in the storage structure, the read request to be serviced from the stored data in the storage structure after a miss in a cache.

Example 23 includes a method comprising: transmitting, at logic circuitry, a Direct Memory Controller Prefetch (DMCP) request to cause a prefetch of data from memory; receiving, at a memory controller, the DMCP request and issuing a plurality of read operations to the memory in response to the DMCP request, wherein data read from the memory in response to the plurality of read operations is stored in a storage structure. Example 24 includes the method of example 23, wherein the storage structure comprises one or more of: a buffer, a cache, a memory side cache, or a memory controller cache. Example 25 includes the method of example 24, wherein the cache comprises a Last Level Cache (LLC).

Example 26 includes an apparatus comprising means to perform an operation as set forth in any preceding example. Example 27 includes machine-readable storage including machine-readable instructions, when executed, to implement an operation or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic circuitry to transmit a Direct Memory Controller Prefetch (DMCP) request to cause a prefetch of data from memory;
a memory controller to receive the DMCP request and issue a plurality of read operations to the memory in response to the DMCP request,
wherein data read from the memory in response to the plurality of read operations is to be stored in a storage structure.

2. The apparatus of claim 1, wherein the storage structure comprises one or more of: a buffer, a cache, a memory side cache, or a memory controller cache.

3. The apparatus of claim 2, wherein the cache comprises a Last Level Cache (LLC).

4. The apparatus of claim 1, wherein one or more of a processor, the memory controller, and an input/output agent comprise the logic circuitry.

5. The apparatus of claim 1, wherein the data stored in the storage structure is to be used to service a subsequent read request from a processor.

6. The apparatus of claim 1, wherein the memory controller is to store the data read from the memory in the storage structure in response to the plurality of read operations.

7. The apparatus of claim 1, wherein the storage structure is a discrete component from the memory controller, wherein the memory controller is communicatively coupled to the storage structure to allow the memory controller to read/write data from/to the storage structure.

8. The apparatus of claim 1, wherein a page open mode of the memory is to be utilized for the data read from the memory.

9. The apparatus of claim 1, wherein, in response to a read request by a processor for an address that matches an address of an entry stored in the storage structure, the read request is to be serviced from the stored data in the storage structure after a miss in a cache.

10. The apparatus of claim 9, wherein the cache comprises a Last Level Cache (LLC).

11. The apparatus of claim 1, wherein the logic circuitry is to directly transmit the DMCP request to the memory controller.

12. The apparatus of claim 1, wherein a processor core comprises the logic circuitry, wherein the processor core is to transmit the DMCP request to the memory controller.

13. The apparatus of claim 1, wherein the memory comprises one or more of: a memory device with an integrated memory controller, a remote memory with a remote memory controller, and a shared or pooled memory with a shared or pooled memory controller.

14. One or more non-transitory computer-readable media comprising one or more instructions that when executed on a processor configure the processor to perform one or more operations to cause:
logic circuitry to transmit a Direct Memory Controller Prefetch (DMCP) request to cause a prefetch of data from memory;
a memory controller to receive the DMCP request and issue a plurality of read operations to the memory in response to the DMCP request,
wherein data read from the memory in response to the plurality of read operations is to be stored in a storage structure.

15. The one or more computer-readable media of claim 14, wherein the storage structure comprises one or more of: a buffer, a cache, a memory side cache, or a memory controller cache.

16. The one or more computer-readable media of claim 15, wherein the cache comprises a Last Level Cache (LLC).

17. The one or more computer-readable media of claim 14, wherein one or more of the processor, the memory controller, and an input/output agent comprise the logic circuitry.

18. The one or more computer-readable media of claim 14, further comprising one or more instructions that when executed on the at least one processor configure the at least one processor to perform one or more operations to cause the data stored in the storage structure is to be used to service a subsequent read request from the processor.

19. The one or more computer-readable media of claim 14, further comprising one or more instructions that when executed on the at least one processor configure the at least one processor to perform one or more operations to cause the memory controller to store the data read from the memory in the storage structure in response to the plurality of read operations.

20. The one or more computer-readable media of claim 14, wherein the storage structure is a discrete component from the memory controller, wherein the memory controller is communicatively coupled to the storage structure to allow the memory controller to read/write data from/to the storage structure.

21. The one or more computer-readable media of claim 14, further comprising one or more instructions that when executed on the at least one processor configure the at least one processor to perform one or more operations to cause a page open mode of the memory to be utilized for the data read from the memory.

22. The one or more computer-readable media of claim 14, further comprising one or more instructions that when executed on the at least one processor configure the at least one processor to perform one or more operations to cause, in response to a read request by the processor for an address that matches an address of an entry stored in the storage structure, the read request to be serviced from the stored data in the storage structure after a miss in a cache.
